(19) United States
(12) Patent Application Publication
(10) Pub. No.: US 2002/0073615 A1
(43) Pub. Date: Jun. 20, 2002

(54) Elevated gazebo garden planter

(76) Inventors: Eric V. Johnson, Indianapolis, IN (US); Ralph E. Vaughn, Muncie, IN (US)

Correspondence Address: C. John Brannon, Woodard, Emhardt, Naughton, Moriarty and McNett, Bank One Center/Tower, 111 Monument Circle, Suite 3700, Indianapolis, IN, 46204-5137, US

(21) Appl. No.: 09/908,060

(22) Filed: Jul. 18, 2001

Related U.S. Application Data
(60) Provisional application No. 60/219,541, filed on Jul. 20, 2000.

(51) Int. Cl. A01G 9/02

(52) U.S. Cl. 47/66.6

(57) ABSTRACT

An elevated planter assembly including a cross member support structure assembly anchored in the ground and extending upwardly about four feet therefrom and having a planter bed portion connected thereto. The planter bed portion includes a pair of substantially vertical sidewalls positioned substantially parallel to each other, a pair of substantially vertical endwalls, a centerline extending substantially parallel to the sidewalls and positioned between, a bottom portion extending from each sidewall toward the centerline and connected to each endwall, a drain positioned between the bottom portions, and a grate extending between the bottom portions and across the drain portion. A deck portion is constructed around the perimeter and anchored into the ground.

### CROSS-REFERENCE TO RELATED APPLICATIONS

This application claims priority to U.S. Provisional Application Serial No. 60/219,541 filed Jul. 20, 2000.

### TECHNICAL FIELD OF THE INVENTION

The present invention generally relates to gardening devices and, more particularly, to an elevated gazebo garden planter.

### BACKGROUND OF THE INVENTION

Gardening is a time-honored activity enjoyed by many people. It is also an activity that traditionally requires certain physical demands from the gardener, including crawling, squatting, and kneeling in the garden. In general, the gardener must be able to physically roam through the garden, often on all fours, in order to properly perform most gardening tasks. For those who enjoy the gardening hobby, the onset of a physical disability, either sudden or gradual, that prevents one from being able to physically enter the garden can be heartbreaking.

Another gardening problem that is especially acute to the disabled gardener is the problem of exhausted soil. As in farming, garden soil may become depleted of essential nutrients and minerals through repeated seasons in which the same or similar plants are grown therein. This problem is addressed in farming through the technique of crop rotation and/or through the use of chemicals that replace the depleted elements from the soil. However, it is often prohibitively difficult and expensive for the gardening hobbyist to obtain and use such soil rebuilding chemicals. Moreover, the use of such chemicals often requires expensive and specialized equipment unavailable to the hobbyist. Furthermore, the techniques of crop rotation often require the soil to lay fallow for a season and/or to be planted with specific crops to reverse the depletion effects. These techniques are of limited appeal to the gardening hobbyist, who is by nature growing specific plants for recreation and enjoyment.

One solution to the above problems is to provide a miniature garden to the gardener in the form of a window box or the like. The window box is easily portable and the soil within can be readily replaced if it becomes depleted. However, while such a solution allows the disabled gardener to have some access to some limited gardening activities, like planting seeds in soil, watering the sprouted seeds, and so forth, a window box is by definition small and cannot approximate the complex tasks and interactions of a full scale garden. As yet, there is still a need for a means to allow disabled gardeners to practice gardening in a large or full-scale garden and also to be able to readily replace worked out or depleted soil. The present invention is directed toward meeting this need.

### SUMMARY OF THE INVENTION

In one embodiment, the present invention relates to an elevated planter assembly including a planter bed portion supported by a cross member support structure assembly anchored in the ground and extending upwardly therefrom. The planter bed portion includes a pair of substantially vertical sidewalls positioned substantially parallel to each other, a pair of substantially vertical endwalls, a centerline extending substantially parallel to the sidewalls and positioned between, a bottom portion extending from each sidewall toward the centerline and connected to each endwall, a drain positioned between the bottom portions, and a grate extending between the bottom portions and across the drain portion. A deck portion is constructed around the perimeter and anchored into the ground.

In another embodiment, the present invention relates to a method of manufacturing an elevated planter assembly, comprising the steps of marking footer locations on the ground, digging footers, providing a plurality of cross member support structure assemblies, positioning the plurality of cross member support structure assemblies in the respective footers, anchoring the plurality of cross member support structure assemblies in the respective footers, connecting each cross member support structure assembly by a lattice of planter bed brace boards, inserting planter bed bottom portions over the lattice of planter bed brace boards, connecting oppositely disposed sidewall portions to the respective planter bed bottom portions, and connecting oppositely disposed endwall portions to the respective sidewall and bottom portions.

One object of the present invention is to provide an improved elevated planter box accessible and operable by the handicapped. Related objects and advantages of the present invention will be apparent from the following description.

### BRIEF DESCRIPTION OF THE DRAWINGS

FIG. 1A is a perspective view of a first embodiment of the present invention, a deck centered on an elevated planter box.

FIG. 1B is a partial cross-sectional schematic view of the planter box of FIG. 1.

FIG. 2 is a schematic view for a ground template for digging the footers illustrated in FIG. 1B.

FIG. 3 is a schematic view of a template for building the cross member support structure assemblies of FIG. 1B.

FIG. 4 is a partial cross-sectional schematic view of a cross member support structure assembly of FIG. 1B suspended in a pair of footers.

FIG. 5 is a top plan schematic view of a bed board brace lattice and flooring segment configuration for the bottom portions of FIG. 1B.

FIG. 6 is a top plan schematic view of FIG. 1A.

FIG. 7 is a schematic side view of the deck and rail configuration of FIG. 1A.

### DETAILED DESCRIPTION OF THE PREFERRED EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended, and alterations and modifications in the illustrated device, and further applications of the principles of the invention as illustrated therein are herein contemplated as would normally occur to one skilled in the art to which the invention relates.

As used herein, the term “upwardly” indicates a direction opposite the pull of the Earth's gravity. The term “downwardly” indicates a direction opposite upwardly. The term “horizontal” means generally parallel to the plane of the horizon. The term “vertical” means perpendicular to the plane of the horizon.

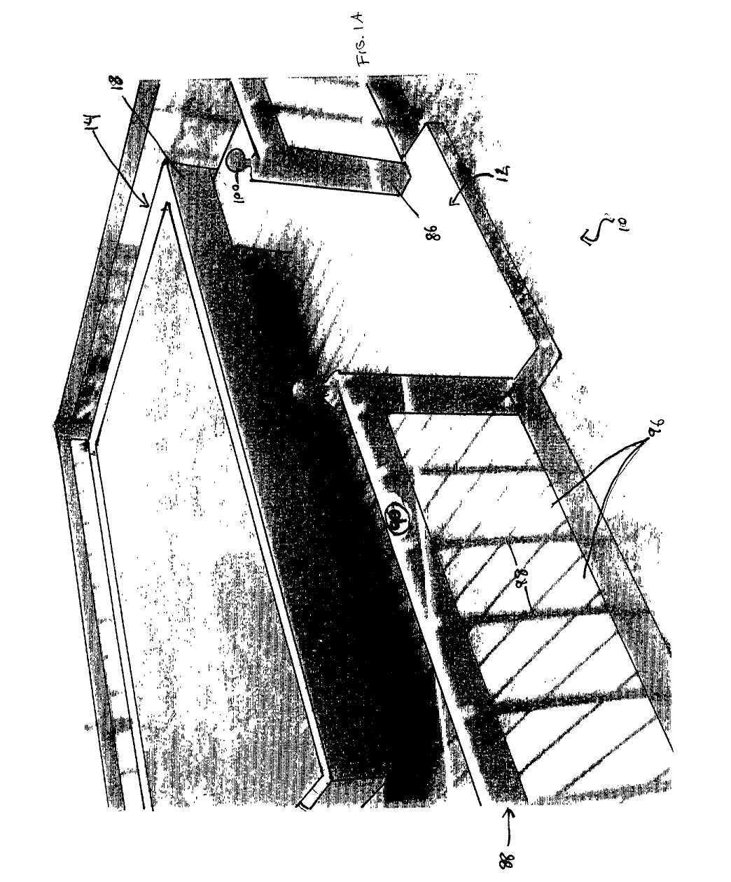

FIGS. 1A and 1B illustrate a first embodiment of the present invention, an elevated gazebo garden planter 10 including a gazebo or deck portion 12 and a planter bed portion 14. The planter portion 14 is preferably anchored into the ground with the deck portion 12 positioned therearound to provide a protection against exposure of the soil to harsh weather elements while allowing a gardener to perform a wide variety of gardening related functions from a seated position using a chair equipped with wheels.

FIG. 1B is a cross-sectional view of the planter bed portion 14. The planter bed portion 14 preferably has a generally V-shaped cross-section (taken perpendicular to its centerline 16) defined by substantially vertically oriented parallel sidewalls 18 from which respective bottom portions 20 extend toward the centerline 16. The sidewall and bottom portions 18, 20 are preferably formed from ¾ inch thick CCA treated plywood, but may be any convenient weather resistant structural materials. The bottom portions 20 preferably slope at a downward angle 22 of approximately 30 degrees from the horizontal as they extend towards the centerline 16 of the planter bed portion 14. The downward angle 22 provides a means by which water may drain from the planter bed portion 14.

A grate 24 is positioned over a planter drain opening 26 defined by the incomplete juncture of the bottom portions 20 at the centerline 16. The grate 24 is preferably covered with a layer of landscape rock 27 or the like. A layer of topsoil 28 sufficiently thick to support plant growth is then positioned over the rock layer 27. The grate 24 is preferably made of a structural material such as aluminum or galvanized steel, but may be made of any convenient structural material. Preferably, the bottom and sidewall portions 20, 18 railings are covered with a flexible, insulative sub-layer 30 (preferably grade #15 roofing felt or the like) and a top layer 32 structural flashing material (preferably aluminum or the like). The insulative sub-layer 30 and the flashing layer 32 are preferably curled around the edge of the respective sidewall and bottom portions 18, 20 and fastened on the underneath side. The completed planter box portion 14 may then be filled with topsoil 34. This construction fabrication technique prevents excess water drainage from running under the above-mentioned layers 30, 32 and penetrating the bottom portion 20 situated therebelow. The bottom portions 20 are preferably pre-painted on both sides with a desired color paint and are more preferably covered with liquid plastic coating prior to assembly.

The planter box portion 14 is supported by a pair of brace boards 36 (preferably 8′ in length) extending downwardly from the respective bottom portions 20 to the ground and further extending into footers 38 formed in the ground. The brace boards 36 preferably cross (i.e., have an X-shaped cross section), intersecting below the centerline 16. The brace boards 36 more preferably intersect directly below the centerline. The footers 38 are preferably filled with an anchoring material 40, such as poured concrete or resin.

Vertical support members 42 are preferably likewise anchored in the footers 38. Each vertical support board 42 extends upwardly from a footer 38 to supportingly intersect a respective brace board 36. Preferably, each vertical support member 42 is about 4.5 feet long. More preferably, each vertical support member extends vertically upwardly from the ground for between about three and four feet. In addition, a horizontal cross member brace board 44 extends substantially horizontally from one brace board 36 to the other brace board 36, and is preferentially positioned between the intersection of the two brace boards 36 and the centerline 16. The horizontal cross member brace board 44 is more preferably positioned adjacent the bottom portions 20, and is still more preferably positioned such that it is directly supported by the vertical support members 42. The horizontal brace board is preferably about 4′ long. The posterior and anterior ends of the planter bed portion 14 are enclosed with endwalls 46 (preferably boards treated to resist water damage, as with, for example, CCA and/or liquid plastic).

The above described brace and support boards 36, 42, 44 form a cross member support structure assembly 50 and are preferably 2″ by 4″ boards, more preferably painted to match or compliment the sidewall and bottom portions 18, 20, are still more preferably covered with a liquid plastic coating or the like, and are yet more preferably covered with a layer of flexible insulative material 52 (such as roofing felt) and a layer of structural flashing material 54 (such as aluminum). The layers 52, 54 are preferably positioned in the middle of the brace boards 36, 44, 42 where they are most likely to be exposed to soil drainage water.

Construction of the Planter

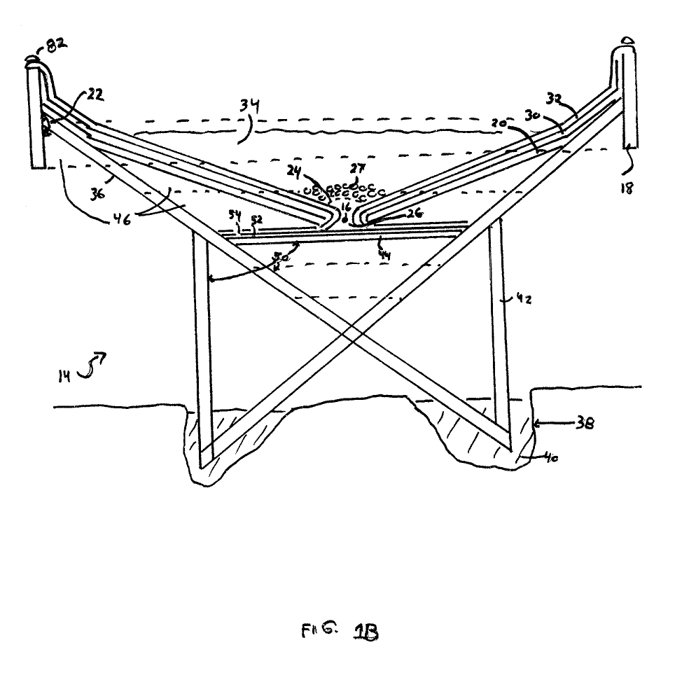

In the preferred embodiment, there are two pre-construction unit fabrication techniques that are employed before construction of the elevated gazebo garden planter 10 is started. The first pre-construction special unit fabrication technique involves making a ground template 60 to mark on the ground surface of the selected construction site exactly where each footer 38 will be dug for installation of the unit cross member support structure assembly 50 (see FIG. 2). The ground template 60 is fabricated using any suitable material, such as a 10-foot by 20-foot piece of industrial plastic tarpaulin material. Footer holes 62 are formed through the ground template 60 as guides for digging the footers 38. The footer holes 62 are preferably arranged in two parallel rows, since this is also the preferred positioning of the footers 38. The number of footer holes 62 cut in the template 60 depends on the length of the desired planter bed portion 14. For example, an 8-foot planter bed 14 may require only 6 footer holes 62, while a 12-foot planter bed 14 may require 8 footer holes 62 and a 16-foot planter bed 14 may require 10 footer holes 62. The footer holes 62 are preferably square-shaped, but may be formed in any convenient shape. Preferably, a single ground template 60 can be used to construct both the larger and the smaller planter beds 14, simply be only using the portion of the ground template appropriate to mark the position of the footers 38 necessary to support the planter bed 14 of the desired size. For the full-size ground template 60, ten square holes are cut (preferably sized 12 inches by 18 inches) in the ground template tarpaulin 60. The tarpaulin 60 is fastened to the ground, such as by driving corner stakes therethrough. Once the tarpaulin template 60 has been secured to the ground at the selected site, a can of white spray paint (or the like) is used to spray along the inside edge of the correct number of holes 62 that correspond to the size of the planter bed portion 14 that is to be built. As described above, if an 8-foot planter box 14 will be built, six holes 62 will preferably be used and sprayed. Likewise, if a 12 foot model is desired to be built, 8 holes 62 will be marked for digging, and if a 16 foot planter box 14 is desired, all 10 holes 62 will be marked for digging. Each footer 38 will be dug to a depth of approximately 8 to 12 inches at its deepest point, as illustrated in FIG. 1.

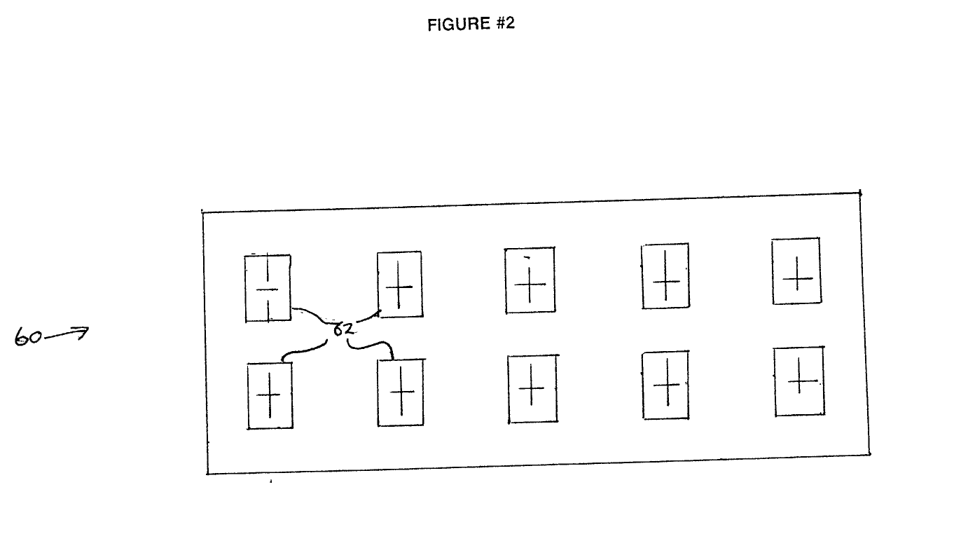

The cross member support structure assembly 50 is preferably constructed using a cross member support structure manufacturing template guide 64, as shown in FIG. 3. Although the cross member support structure assembly 50 may be constructed without the use of the template guide 64, the guide 64 provides an easy means by which properly dimensioned boards may be connected to each other to form a unit cross member support structure assembly 50, each set enjoying substantially identical dimensions. It is desirable that there be as little dimensional variance as possible in the cross member support structure assemblies 50, such that a person of average, or non-extraordinary carpentry skill may readily assemble the cross member support structure assemblies 50 and position the assemblies 50 in alignment with each other to provide support for the planter box 14. Preferably, the template guide 64 includes a sheet of flat structural material 66, such as ⅝″ thick particle board, sufficiently large to accommodate the assembly of a cross member support structure assemblies 50. Board guides 68 are attached to the flat sheet 66 and are positioned to guide the various brace and support boards 36, 42, 44 into the appropriate cross member support structure assembly 50 configuration, where they can be connected by any convenient means, such as by nailing or bolting. The board guides 68 are preferably formed from pairs of spaced 2″ by 2″ blocks fastened to the flat sheet 66, spaced to accommodate the various brace and support boards 36, 42, 44. Once completed, the cross member support structure assembly 50 is merely removed from the face of the template 64 to make room for fabrication of the next cross member support structure assembly 50. Once the cross member support structure assembly template 64 and the requisite number of cross member support structure assemblies 50 have been constructed, the cross member support structure assemblies 50 are secured in the footers 38.

Using the above mentioned ground template 60 for the installation of an 8 foot planter bed 14 as an example, this will preferably include the installation of three cross member support structure assemblies 50 to be inserted in the ground at the preselected construction site. Once template markings have been made and all six footers 38 have been properly dug, the first of three cross member support structure assemblies 50 will be ready for installation.

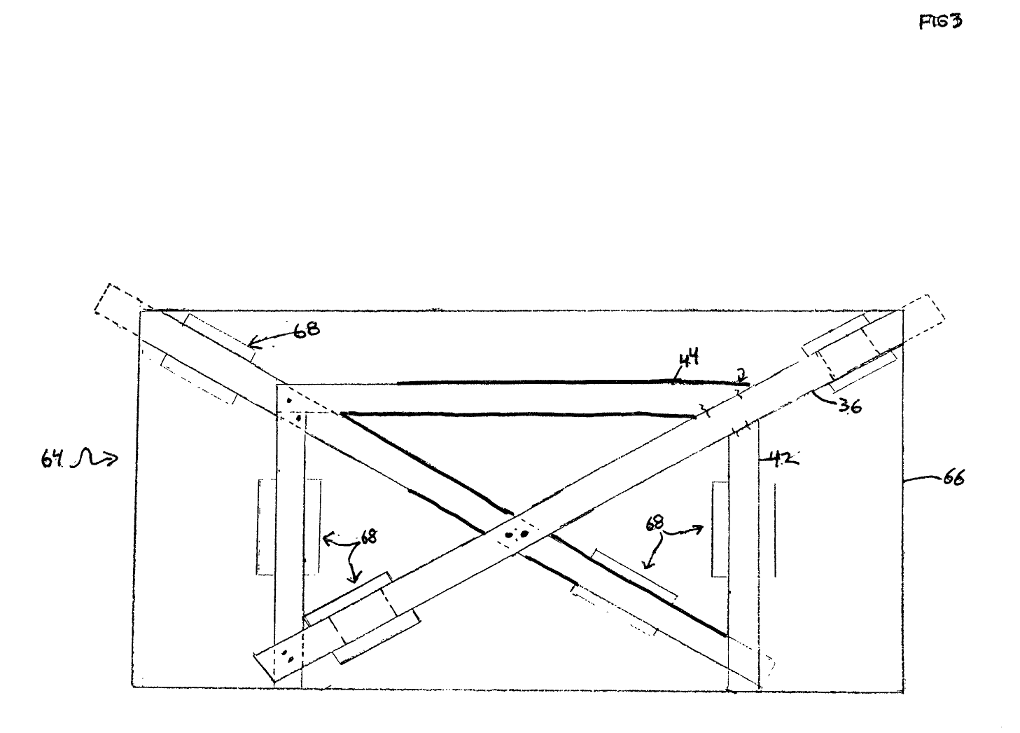

One preferred technique for installing the cross member support structure assemblies 50 is illustrated in FIG. 4 and discussed below, although other installation techniques familiar to one of ordinary skill in the art may alternately be used. First, a cross member support structure assembly 50 is temporarily attached to a 2″×4″×12′ board 70 using two “C” vice-clamps. The board 70 is attached to the cross member support structure assembly 50 at the two upper ends. The board 70 is preferably kept substantially level. The board 70 is then supportingly connected to two telescoping stands 72 at either end. The cross member support structure assembly 50 may then be suspended over the footers 38. A carpenter's level may now be placed on top of the board 70 to assure that the suspended cross member support structure assembly 50 is properly level. In addition, the telescoping stands 72 that will eventually carry the other two unit cross member support assembly structures may be moved and otherwise adjusted to assure for proper distance apart from each other a distance of 46 inches as illustrated in FIG. 1.

Once the first cross member support structure assembly 50 has been properly leveled and suspended over its footers 38, poured concrete 40 or the like may now be placed in the designated footers 38, such that the at least a portion of the assembly 50 is encased in the poured concrete 40. The freshly poured concrete 40 is preferably permitted to harden for a period of at least about two hours prior to beginning installation of the next cross member support structure assembly 50. Once anchored, the cross member support structure assembly preferably extends upwardly about four feet.

Following the preferred two hour wait for the concrete 40 in the first set of footers 38 to partially harden, installation of the next cross member support structure assembly 50 can begin. The next cross member support structure assembly 50 to be installed is the one that will be placed at the opposite end from the first cross member support structure assembly 50. The middle cross member support structure assembly(ies) 50 are preferably installed last. The installation of the second of three cross member support structure assemblies 50 is done in substantially the same manner as the installation of the first one described above. However, a measurement of 92″ from each vertical brace board 42 of the first cross member support structure assembly 50 is preferably made to assure that the cross member support structure assemblies 50 remain plum with one another. In addition, cord lines 76 are attached to the first cross member support structure assembly 50 at points therealong. These cord lines 76 are stretched and attached to the second cross member support structure assembly 50 at corresponding points thereon. The cord lines 76 are preferably stretched sufficiently taught such that a carpenter's level may be placed along side each line 76 to check levelness. This procedure will insure that the first two installed cross member support structure assemblies 50 are level and plum to each other. The second cross member support structure assembly 50 may now be permanently mounted in its footers 38 by filling the footers 38 with poured concrete 40 as above.

The third (and, in the case of an 8-foot planter bed portion 14, final) cross member support structure assembly 50 may now be inserted in place substantially in the middle between the first two cross member support structure assemblies 50. As discussed above, the middle cross member support structure assembly 50 is preferably installed 46 inches on center between the two end assemblies 50. Since the cord lines 76 that are stretched between the existing two assemblies are preferably left in place as guides, installation of the third cross member support structure assembly 50 is relatively straightforward. The third assembly 50 may be inserted in place over its designated footers 38 in such a manner as to have it simply touch the out stretched cord lines 76 at corresponding points to those of the first two assemblies 50. The third cross member support structure assembly 50 may then be emplaced in its footers 38 and anchored in poured concrete 40.

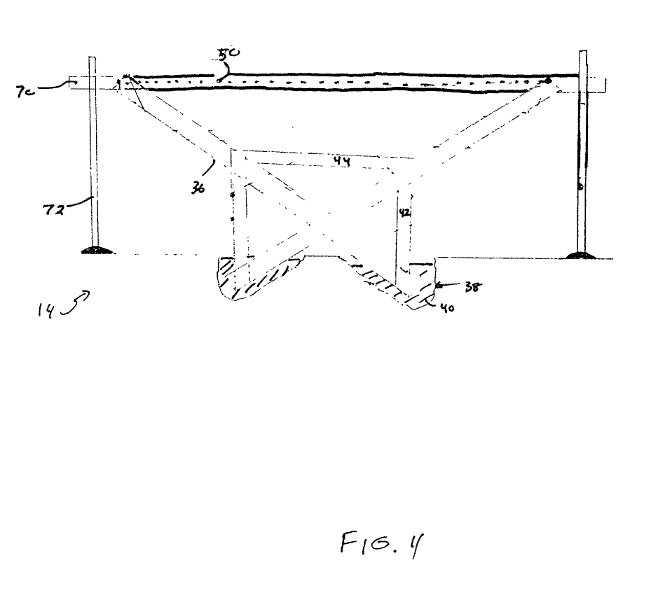

Once the three cross member support structure assemblies 50 have been anchored, they are preferably connected together using CCA treated, pre-painted and polyurethane treated 2″×4″ boards 80, as illustrated in FIG. 5. The planter bed floor brace boards 80 are preferably positioned in such a manner as to connect each cross member support structure assembly 50 by a lattice of brace boards 80. Once the desired number of planter bed brace boards 80 have been installed, the planter bed bottom portions 20 will need to be inserted over the brace boards 80. The planter bed bottom portions 20 are preferably constructed from structural flooring segments 81. Each flooring segment 81 is preferably CCA treated, pre-painted and polyurethane treated (on both sides). Each flooring segment 81 is more preferably provided as a piece of 4′×8′×¾″ sized plywood sheeting. The flooring segments 81 are then preferably cut to a dimension of 2′×8′×¾″ to facilitate proper installation. Each flooring segment 81 is preferably attached to the cross member support structure assembly 50 and underneath brace boards 80 using three inch construction screws. In fact, all board connections are preferably made with various sizes of construction and/or deck screws to best ensure a tight secure fit. Prior to securing the pieces of plywood floor sheeting 20 to the cross member support structure assemblies 50 and underneath brace boards 80, two top layers of additional protecting materials 30, 32 are preferably attached thereto. The first layer 30 is a flexible insulator, such as #15 pound roofing felt. The second layer 32 is preferably structural flashing, such as 20-inch wide sheet aluminum. Both the insulation and flashing layers 30, 32 are attached to the planter bed bottom portions 20 in such a manner as to be wrapped around the long side of each respective bottom portion 20. The wrapped-around edge of the bottom portion 20 containing the roofing felt and aluminum flashing layers 30, 32 is positioned adjacent the centerline 16 next to the drain opening 26 (see FIG. 1). These sub layers 30, 32 of roofing felt and aluminum flashing material are then placed on the floor board 20 overlapping as it extends toward the sidewall 18. The sub layers 30, 32 preferably extend beyond the floor board 20 and up the sidewall 18.

When the sub layers 30, 32 reach the top of the sidewall 18, they are rolled over the top of the sidewall 18 and fastened thereto. A molding strip 82 (see FIG. 1B) is then preferably used to cover all ends of the cut sublayers 30, 32. Endwalls 46, preferably consisting of CCA treated, pre-painted and polyurethane coated 2″×12″×8′ boards, are then placed on both ends of the planter box 14 to connect with the existing sidewalls 18 to enclose the planter box 14. Preferably, the endwalls 46 are 2″×4″ boards placed under the 2″×12″ boards and are more preferably cut at angles on both ends to match the “V” shaped opening under the 2″×12″ floor and sidewalls 20, 18. Upon installation of these additional 2″×4″ endwalls 46 to enclose the planter box 14, the inside surface is also preferably covered with sublayers 30, 32 (i.e., roofing felt and aluminum flashing material). The roofing felt material and surface aluminum flashing ends that over lap onto the unit planter bed floor layers 30, 32 are then preferably sealed using an all purpose weather resistant adhesive sealant. More preferably, all other areas where the under layers create seems are also so sealed. This sealing process prevents any moisture form the planter bed 14 or excess water from getting underneath to the surface and causing water/moisture damage thereto. Any excess roofing felt and/or aluminum flashing materials that may extend over the sides of the planter bed 14 are preferably trimmed and concealed beneath the molding strip 82.

An aluminum or galvanized steel grate 24 is cut to size and fitted over the drain opening 26 at the middle of the planter bed floor 20. Landscaping rock riprap material 27 (or the like) is placed over the grate 24 to help facilitate proper drainage. The planter 14 is now preferably filled to the top with good quality topsoil 34.

Construction of the Deck

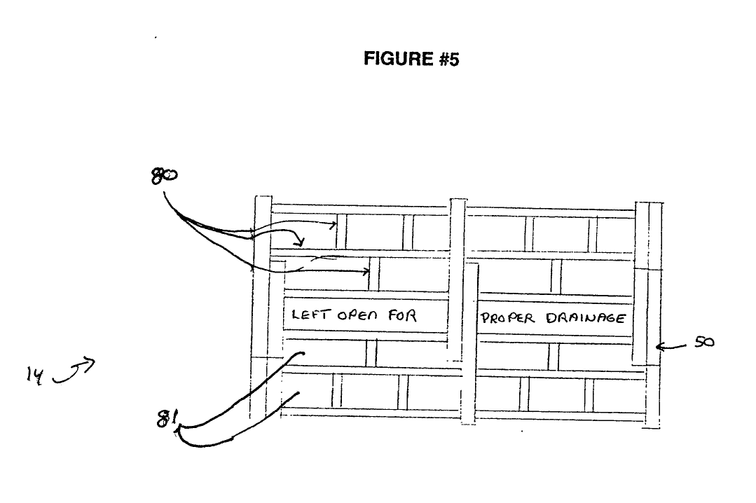

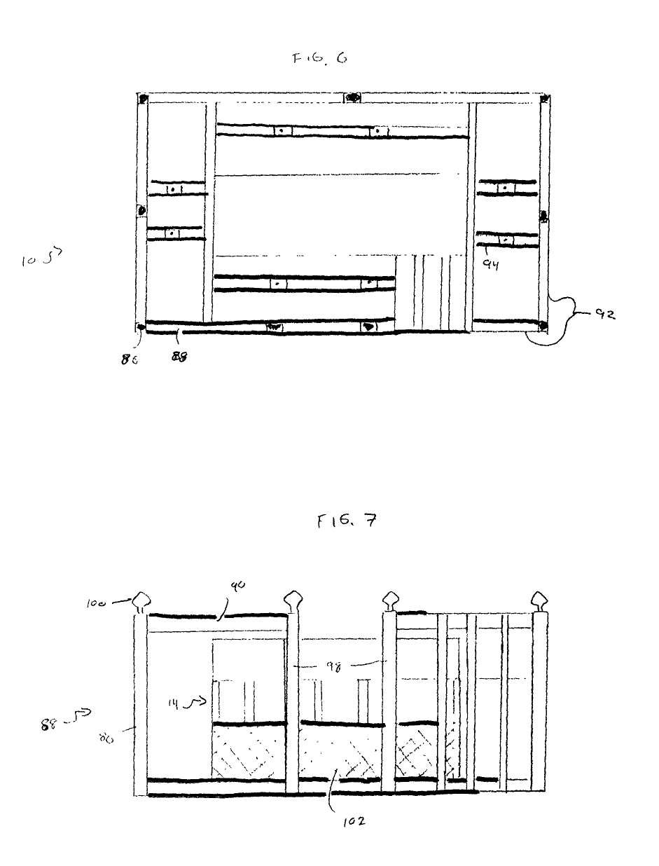

A prescribed area, such as a three feet perimeter from the edge of the planter bed 14, is marked on the ground all the way around the planter 14. A number of footer holes 38 are dug to accommodate 4″×4″×4′ posts 86 to support a deck railing system 88, as indicated on FIG. 6. Preferably, there are nine posts 86 and so nine footers 38 are correspondingly dug. Each post 86 is preferably set about one foot deep in a respective footer hole 38, which is then filled with poured concrete 40. The posts 86 are preferably connected by CCA treated pre-painted and polyurethane coated 2″×6″ rail boards 90. Additional 2″×6″ deck floor support boards 92 with corresponding deck supports 94 anchored in concrete are likewise installed. Once all unit deck floor supports 92 are in place, 2″×6″ deck boards 96 are laid to form the deck floor. These deck boards 96 are preferably spaced 2 inches apart from each other across the deck floor surface. Once again, the deck boards 96 are preferably CCA treated, pre-painted and treated with polyurethane coating prior to assembly. Following completion of the floor board 96 installation, the rail system 88 if preferably installed. Installation of the rail system 88 comprises connection of the nine posts 86 at the top by horizontally positioned 2″×6″ rail boards 90. The spaces between the posts 86 are preferably partially filled using CCA treated 2″×2″×3′ picket boards 98 extending vertically at one foot intervals around the perimeter of the deck portion 12. A decorative post cap 100 may be installed atop each respective post 86. Latticework 102 may then be installed at the base of the deck portion 12. Again, the latticework 102 is preferably CCA treated and is pre-painted and coated with polyurethane coating prior to installation.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A combination, comprising:
a cross member support structure assembly;
a planter bed portion having a bottom and connected to the cross member support structure assembly; and
wherein the cross member support structure assembly is anchored in the ground.

2. The combination of claim 1 wherein the planter bed portion is characterized by a generally V-shaped cross-section.

3. The combination of claim 1 wherein the cross member support structure assembly extends upwardly about four feet from the ground.

4. The combination of claim 1 wherein the planter bed portion further comprises:
an anterior end;
a posterior end;
a pair of substantially vertical sidewalls positioned substantially parallel to each other;
a centerline extending substantially parallel to the sidewalls and positioned between;
a bottom portion extending from each sidewall toward the centerline;
an endwall positioned at each respective end and extending across the sidewall and bottom portion;
a drain portion positioned between the bottom portions; and
a grate extending between the bottom portions and across the drain portion.

5. The combination of claim 4 wherein the centerline is positioned substantially equidistant from each sidewall.

6. The combination of claim 4 wherein each bottom portion further comprises:
at least one structural flooring segment;
a layer of flexible insulating material adjacent the at least one structural flooring segment;
a layer of structural flashing adjacent the layer of flexible insulating material.

7. The combination of claim 6 wherein the at least one structural flooring segment is CCA treated, pre-painted and polyurethane treated plywood sheeting; wherein the flexible insulating material is roofing felt; and wherein the structural flashing material is aluminum.

8. The combination of claim 4 wherein the planter bed portion is further characterized as having a perimeter and further comprising a deck constructed around the perimeter and anchored into the ground.

9. An elevated planter, comprising:
a cross member support structure assembly anchored in the ground and extending upwardly about four feet therefrom;
a planter bed portion connected to the cross member support structure assembly and further comprising:
a pair of substantially vertical sidewalls positioned substantially parallel to each other;
a pair of substantially vertical endwalls;
a centerline extending substantially parallel to the sidewalls and positioned between;
a bottom portion extending from each sidewall toward the centerline and connected to each endwall;
a drain portion positioned between the bottom portions; and
a grate extending between the bottom portions and across the drain portion;
wherein the planter bed portion is characterized by a perimeter; and
a deck portion constructed around the perimeter and anchored into the ground.

10. The elevated planter of claim 9, wherein the bottom portion further comprises at least one structural flooring segment; wherein a flexible insulating layer substantially covers the bottom portion, the sidewalls, and the endwalls; and wherein a flashing layer is substantially adjacent the insulating layer.

11. The elevated planter of claim 9 wherein the cross member support structure assembly, the planter bed portion and the deck portion are all treated with CCA.

12. A template guide for constructing a cross member support structure assembly, comprising:
a sheet of flat structural material; and
a plurality of board guides attached to the sheet and positioned to guide boards into a cross member support structure assembly configuration;
wherein the board guides are spaced to accommodate the boards;
wherein the board guides further comprise pairs of spaced 2″ by 2″ blocks connected to the sheet; and
wherein the sheet of flat structural material is sufficiently large to accommodate the assembly of a cross member support structure assembly.

13. A method of manufacturing an elevated planter assembly, comprising the steps of:
a) marking footer pair locations on the ground;
b) digging footer pairs;
c) providing a plurality of cross member support structure assemblies;
d) positioning the plurality of cross member support structure assemblies in the respective footers;
e) anchoring the plurality of cross member support structure assemblies in the respective footers;
f) connecting each cross member support structure assembly by a lattice of planter bed brace boards;
g) inserting planter bed bottom portions over the lattice of planter bed brace boards;
h) connecting oppositely disposed sidewall portions to the respective planter bed bottom portions; and
i) connecting oppositely disposed endwall portions to the respective sidewall and bottom portions.

14. The method of claim 13, wherein each cross member support structure assembly further comprises:
a pair of crossed brace boards; a vertical support members supportingly connected to each respective brace board; and a horizontal cross member brace board connected between the brace boards; and
wherein step c further comprises the steps of:
c1) providing a template guide;
c2) positioning appropriately dimensioned boards in the template guide; and
c3) fastening the boards together.

15. The method of claim 13 wherein step a further comprises the steps of:
a1) providing a ground template having appropriately positioned holes therein;
a2) positioning the ground template on the ground whereupon the planter bed is desired to stand; and
a3) marking the ground through the holes.

16. The method of claim 13 wherein step d further comprises the steps of:
d1) clamping a first cross member support structure assembly to an elongated level board;
d2) supportingly connecting the board to a plurality of telescoping stands; and
d3) suspending the first cross member support structure assembly over a first footer pair.

17. The method of claim 16, further comprising the comprising the steps of:
d4) anchoring the first cross member in the footer pair;
d5) placing a second cross member support structure assembly over a second footer pair opposite the first cross member support structure assembly;
d6) attaching cord lines to the first cross member support structure assembly at preselected points;
d7) stretching the cord lines and attaching the cord lines to the second cross member support structure assembly at corresponding points;
d8) ensuring that the first two installed cross member support structure assemblies are level and plum to each other;
d9) anchoring the second cross member support structure assembly in the second footer pair; and
d10) inserting a third cross member support structure assembly between the first two end cross member support structure assemblies.

18. The method of claim 13 wherein the cross member support structure assemblies are anchored in the respective footers by poured concrete.

19. The method of claim 13 wherein each bed bottom portion is comprised of a plurality of connected flooring segments.

20. The method of claim 13 further comprising the steps of:
j) connecting a layer of flexible insulating material substantially adjacent the planter bed bottom portions, the sidewalls, and the endwalls; and
k) connecting a layer of flashing material substantially adjacent the layer of flexible insulating material.

21. The method of claim 13 further comprising the steps of:
l) forming a drain between the bottom portions;
m) placing a grate over the drain; and
n) placing a layer of rocks over the grate.

22. The method of claim 13 further comprising the step of:
o) substantially sealing the elevated planter assembly.

23. The method of claim 13 further comprising the steps of:
p) building a deck around the elevated planter assembly; and
q) sealing the deck.
